(19) United States
(12) Patent Application Publication
(10) Pub. No.: US 2026/0117754 A1
(43) Pub. Date: Apr. 30, 2026

(54) SYSTEM FOR THE GENERATION OF GRAVITATIONAL WAVES

(71) Applicant: Alabama A&M University, Normal, AL (US)

(72) Inventor: Chance Michael Glenn, SR., Huntsville, AL (US)

(21) Appl. No.: 19/376,558

(22) Filed: Oct. 31, 2025

Related U.S. Application Data
(60) Provisional application No. 63/714,801, filed on Oct. 31, 2024.

(51) Int. Cl. F03H 99/00; B64G 1/40

(52) U.S. Cl. CPC F03H 99/00; B64G 1/409

(57) ABSTRACT

A system can produce localized spacetime distortions, gravitational waves, sudden transitions in the index of refraction and optical path length changes via high-energy plasma formation. The system includes a high-energy spark-gap arrangement, where an electrical discharge between tungsten tips produces extremely high energy densities in a localized region. The system is tunable and can be driven by either constant or time-varying voltage sources, allowing for different distortion profiles and electromagnetic emission patterns. The system can operate in various environments, including air, inert gases such as helium, and even in vacuum conditions. Multiple spark-gap assemblies can be arranged to create customized distortion shapes and enhanced field effects.

### CROSS-REFERENCE TO RELATED APPLICATIONS

This application claims the benefit of U.S. Provisional Patent Application No. 63/714,801, filed Oct. 31, 2024, and entitled “Apparatus for the Generation of Gravitational Waves and Instantaneous Transitions in Index of Refraction,” which application is hereby incorporated by reference herein in its entirety.

### BACKGROUND

This application generally relates to systems, apparatuses, and devices capable of generating gravitational waves and producing instantaneous transitions in the index of refraction. The system utilizes a spark-gap apparatus, driven by an electrical transformer, that can create high-energy density fields to manipulate spacetime locally, produce detectable gravitational waves, and alter the local optical path lengths instantaneously.

The Einstein field equations describe how the geometry of spacetime (curvature) is influenced by the energy and momentum of matter and radiation that is present. The Einstein field equations are the foundation of general relativity and play a central role in understanding gravitational phenomena. Equation 1 provides some background on the geometry of spacetime.

$${R}_{μ v} - \frac{1}{2} {Rg}_{μ v} = \frac{8 π G}{{c}^{4}} {T}_{μ v} \qquad ( 1 )$$

where
R_{μv}—the Ricci curvature tensor, which represents how much spacetime is curved due to the presence of mass and energy in a particular direction. It is derived from the Riemann curvature tensor by contracting indices.
R—the Ricci scalar, a scalar quantity that represents the degree of curvature of spacetime. It is the trace of the Ricci tensor, obtained by contracting R_{μv} with the metric tensor g_{μv} as set forth in Equation 2:

$$R = {g}_{μ v} {R}_{μ v} \qquad ( 2 )$$

g_{μv}—the metric tensor, which defines the geometry of spacetime. It specifies the distance between nearby points and encodes the gravitational field.
T_{μv}—the stress-energy tensor, representing the distribution and flow of energy and momentum in spacetime. It encapsulates the density of matter, energy, and momentum as well as the pressures and stresses acting within the matter fields.
G—the gravitational constant, a fundamental constant of nature, with an approximate value of 6.674×10⁻¹¹ Nm²/kg².
c—the speed of light in vacuum, another fundamental constant, approximately 3.00×10⁸ m/s.

Recent developments in the field of gravitational wave detection and the theory of spacetime distortion have shown that large energy densities are required to produce detectable curvature or gravitational waves in spacetime. Traditional methods rely on large masses or high-energy processes both of which can be bulky and expensive to implement.

Therefore, what is needed is a compact device that uses controlled electrical energy to produce gravitational waves and achieve spacetime distortions at smaller scales.

### SUMMARY

A spacetime distortion spark-gap system can generate localized spacetime distortions, gravitational waves, and sudden transitions in the index of refraction. The system includes a high-energy spark-gap arrangement, where an electrical discharge between tungsten tips produces extremely high energy densities in a localized region. The system is tunable and can be driven by either constant or time-varying voltage sources, allowing for different distortion profiles and electromagnetic emission patterns. The system can produce gravitational waves that are detectable with interferometers and can manipulate optical paths by altering the index of refraction of the light (e.g., a laser) in the region of the spark. The system can operate in various environments, including air, inert gases such as helium, and even in vacuum conditions. Multiple spark-gap tips can be arranged in embodiments of the system to create customized distortion shapes and enhanced field effects.

The spark-gap system provides a method for producing gravitational waves and optical path length changes via high-energy plasma formation. The spark-gap system can rely on a high-voltage spark-gap discharge and permit the generation of tunable distortion patterns based on spark-gap configuration and energy input. In some aspects, the spark-gap system can be used to generate small, detectable gravitational waves that could serve as a foundation for new propulsion systems. In addition, the spark-gap system can alter light paths (and/or the index of refraction) instantaneously, which can be used as a basis for advanced optical communication technologies, sensor technologies or light-based signal processing or control systems. Further, by producing small-scale spacetime distortions, the spark-gap system may be used as a propulsion system for spacecraft.

One advantage of the present application is the system's potential applications in propulsion systems, gravitational wave detection, space exploration, and advanced physics research.

Another advantage of the present application is that the system is versatile and can be tuned to operate in various environments and configurations.

### BRIEF DESCRIPTION OF THE DRAWINGS

The present application is shown and described herein with reference to the various drawings, in which like reference numbers denote like method steps and/or system components, respectively.

FIG. 1 is a block diagram of an embodiment of gravitational wave generation system.

FIGS. 2 and 3 schematic diagrams of an embodiment of the spark-gap assembly from FIG. 1.

FIG. 4 is a graph showing a variation of the energy density within the spark plasma with respect to time in one embodiment.

FIG. 5 is a block diagram of an embodiment of an interferometric detection system used with gravitational wave generation system of FIG. 1.

FIG. 6A is a schematic diagram showing an increase in optical path length of a laser passing through an embodiment of a spark-gap assembly.

FIG. 6B is a graph showing spacetime compression within a spark in one embodiment.

FIGS. 7 and 8 are graphs showing fringe displacement with respect to distance of the spark from the laser beam for different lasers in one embodiment.

FIGS. 9 and 10 are graphs showing fringe displacement with respect to distance of the spark from the laser beam for different lasers in another embodiment.

FIGS. 11 and 12 are graphs showing energy density with respect to fringe displacement for different spark orientations in one embodiment.

FIG. 13 is a schematic diagram of an embodiment of an array of gravitational wave generation systems.

FIG. 14 is a schematic diagram of an embodiment of arrays of gravitational wave generation systems used for fusion reaction stabilization.

FIG. 15 is a schematic diagram of an embodiment of arrays of gravitational wave generation systems used for propulsion.

FIG. 16 is a schematic diagram of an embodiment of arrays of gravitational wave generation systems used for electromagnetic beam control.

FIG. 17 is a schematic diagram of an embodiment of arrays of gravitational wave generation systems used for medical applications.

FIG. 18 is a schematic diagram of an embodiment of arrays of gravitational wave generation systems used for high-speed communication.

FIG. 19 is a schematic diagram of an embodiment of array of gravitational wave generation systems with time-varying voltage.

FIG. 20 is a block diagram of an embodiment of a control system for the gravitational wave generation system.

### DETAILED DESCRIPTION

The present application may be understood more readily by reference to the following detailed description of the application taken in connection with the accompanying drawing figures, which form a part of this application. It is to be understood that this application is not limited to the specific devices, methods, conditions or parameters described and/or shown herein, and that the terminology used herein is for the purpose of describing particular aspects by way of example only and is not intended to be limiting of the claimed application. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another aspect includes from the one particular value and/or to the other particular value. Similarly, when values are expressed as approximations, by use of the antecedent “about,” it will be understood that the particular value forms another aspect.

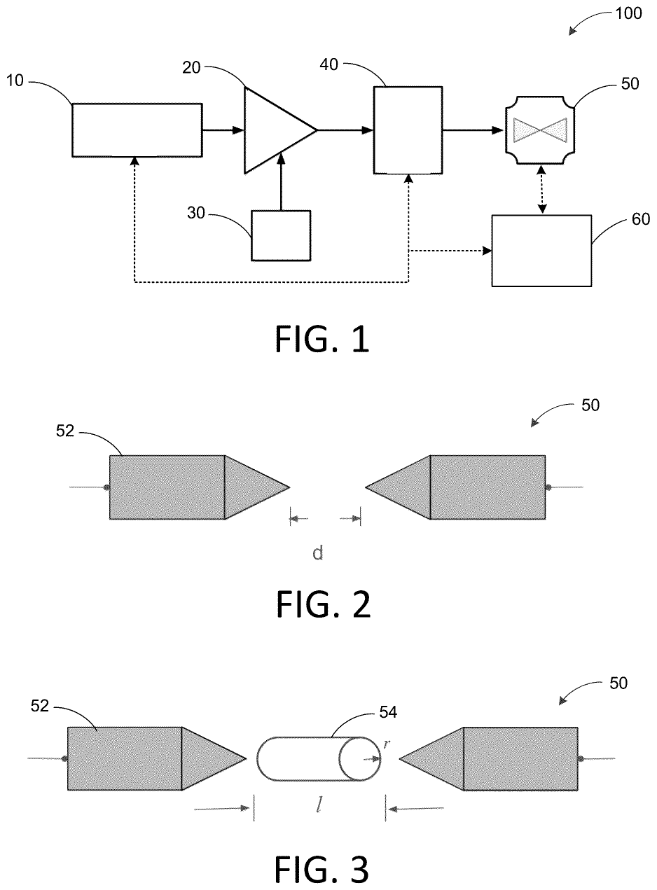

FIG. 1 shows a block diagram of an embodiment of a gravitational wave generation system or a spark-gap system to generate spacetime distortion through high-energy spark formation. The gravitational wave generation system or spark-gap system 100 can include a signal generator 10 providing a signal to an amplifier 20. The amplifier 20 can receive a DC voltage from a DC power supply 30 and amplify the signal from the signal generator 10 to a power level required to drive a transformer 40. The transformer 40 can provide a voltage to a spark-gap assembly 50 such that the spark-gap assembly 50 can break down the air and produce a spark as controlled by a control system 60. The control system 60 can provide for a tunable input voltage and current to the spark-gap assembly 50, which allows for various operational modes of the system 100, including constant and pulsed energy delivery to the spark-gap assembly 50. In one embodiment, the transformer 40 can provide a voltage of approximately 400,000 V (volts) to the spark-gap assembly 50.

FIGS. 2 and 3 schematically show an embodiment of the spark-gap assembly 50. The spark-gap assembly 50 can include a pair of electrodes or tips 52 that are separated by an adjustable distance d, which can define a spark plasma region where the spacetime distortion can occur. In one embodiment, the pair of tips 52 can be tungsten rods filed down to a point or tip of about 0.5 mm, but the tips 52 may be made from any other suitable material and may have any suitable tip dimension in other embodiments. The distance d between the tips 52 can range from about 0.5 mm (millimeters) to about 5 mm to provide for different spark lengths (or gap distances). In one embodiment, the distance d can be 2 mm. By controlling the distance d between the tips 52 in the spark-gap assembly 50, the spark length and/or energy density produced by the spark-gap assembly 50 can be controlled.

A spark initiated by a high electromagnetic field can be used as the foundational structure in the spark-gap assembly. As shown in FIG. 3, the spark 54 can be represented as a cylinder of a particular radius r and length/in order to calculate the energy density within the spark 54 using the known distribution of energy across the volume of the spark 54. In one embodiment, the spark 54 can be a cylinder with a radius r of 0.25 mm and length/of 2.5 mm. The energy density u within the spark volume can be calculated as set forth in Equation 3:

$$u ( t ) = \frac{U ( t )}{V} \qquad ( 3 )$$

where
U(t)—the total input of energy that varies in time in the spark.
V—the volume of the spark (i.e., the cylinder).

U(t) can be further defined by Equation 4:

$$U ( t ) = P ( t ) τ = v ( t ) i ( t ) τ \qquad ( 4 )$$

where
v(t)—the input voltage.
i(t)—the input current.
τ—the pulse length.

The volume V of the spark (i.e., the cylinder) is given by Equation 5:

$$V = π {r}^{2} l \qquad ( 5 )$$

The energy density u can be redefined as set forth in Equation 6:

$$u ( t ) = \frac{v ( t ) i ( t ) τ}{π {r}^{2} l} \qquad ( 6 )$$

With an input energy U obtained from the spark-gap assembly setup, the energy density u can be determined by substituting U and V from Equation 3 as shown in Equation 6. The energy density can be used to determine the gravitational influence of the spark as well as potential spacetime distortions. Given the geometry of the spark (i.e., the cylinder), energy densities in the order of 10¹¹ or 10¹² J/m³ can be achieved, which can lead to several unusual phenomena occurring within the plasmas formed by the energy densities.

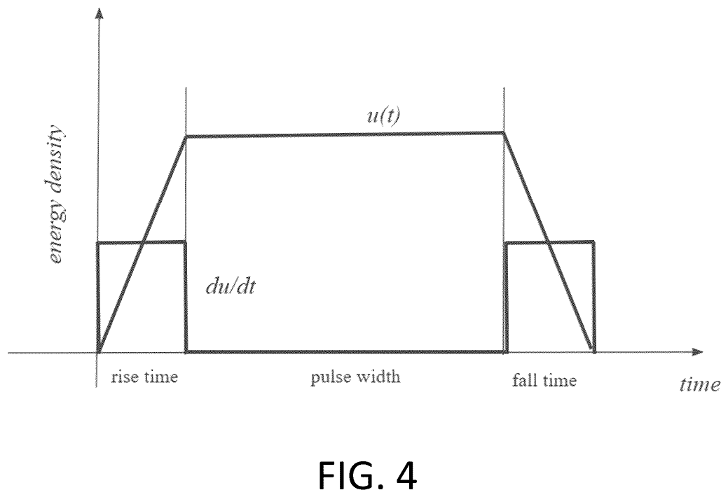

The impact of a rapid change in energy density as the spark is formed can be accounted for by Equation 7, which describes the power density in relation to instantaneous power as shown in FIG. 4:

$$\frac{du}{dt} = \frac{τ}{π {r}^{2} l} \frac{d}{dt} v ( t ) i ( t ) \qquad ( 7 )$$

Strong, time-varying energy density can induce gravitational waves. In addition, changes in the relative position of the energy with respect to time can also induce gravitational waves. In some embodiments, while the gap distance, in combination with the properties of the surrounding gas, can determine the spark formation rate, the signal generator 10 can control the frequency of the sparks once the minimum distance and voltage are established.

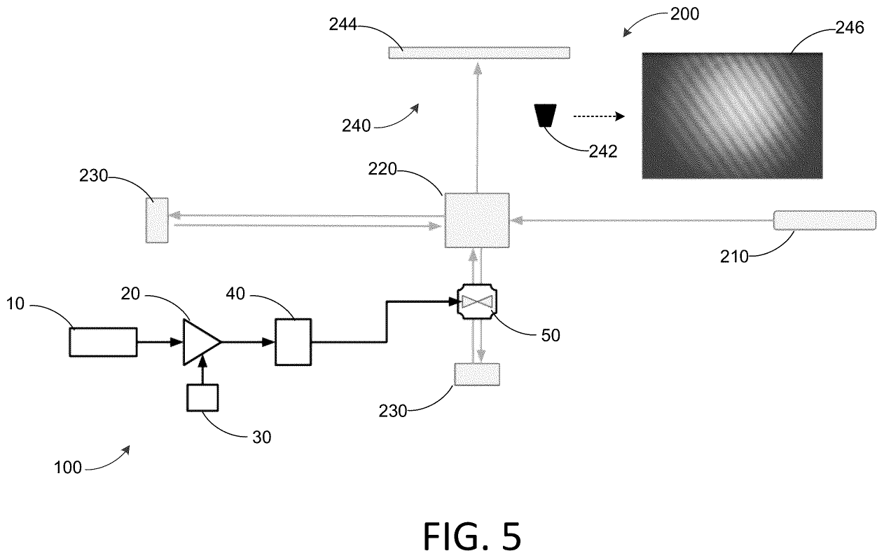

FIG. 5 shows an embodiment of a detection system that can be used with the gravitational wave generation system. An interferometric detection system 200 can be used to measure local distortions in spacetime or refractive index changes in real-time resulting from the generation of gravitational waves by the generation system 100. For example, when the transformer 40 provides high-voltage electrical energy to the spark-gap tips 52 of the spark-gap assembly 50, an electric arc forms between the tips 52, which results in the rapid creation of plasma. The plasma has a dramatically different index of refraction compared to the surrounding air (or gas), resulting in a measurable optical path length change. Thes change in optical path length can be detected using the detection system 200 (e.g., an interferometer). In addition to optical changes, spacetime compression can occur due to the localized high-energy density of the plasma. The energy densities generated are sufficient to produce gravitational waves detectable with the detection system 200.

In one embodiment, the detection system 200 can be a Michelson interferometer arranged in a common path configuration to measure fringe movement caused by spacetime distortions in the spark plasma. The detection system 200 can include a light source (e.g., a laser) 210, a beam-splitter 220, two mirrors 230, and a photodetector system 240 that can record the interference pattern. The detection system 200 can detect changes in fringe patterns when a laser beam from the laser 210 passes through the region affected by the spark-gap assembly 50 (e.g., the spark 54). The light source 210 can be either a 532 nm laser or a 650 nm laser in one embodiment, but other suitable lasers or light sources can be used in other embodiments. In an embodiment, the photodetector system 240 can include a camera 242 that captures images from a screen 244 to produce the interference fringes 244. In one embodiment of the detection system 200, the mirrors 230 can be positioned about 150 mm away from the splitter 220, with the screen 244 about 500 mm away. The spark gap assembly was placed about halfway between one of the mirrored arms 230 and the beam splitter 220.

The detection system 200 can be used to detect nanometer fringe shifts in the spark-gap assembly 50. Fringe movements can be recorded and analyzed across various input power levels and with the spark at various distances away from the laser. Video analysis can be performed to quantify frame-by-frame fringe shifts relative to baseline measurements to track fringe displacements in relation to the light source 210. The gravitational wave strain h is a dimensionless quantity that represents the fractional change in the distance between two points in spacetime due to a passing gravitational wave. In the detection system 200, h relates to the change in the optical path length L as set forth in Equation 8:

$$h = \frac{Δ L}{L} \qquad ( 8 )$$

where
h—the gravitational wave strain.
ΔL—the change in the optical path length caused by spacetime distortion.
L—the original optical path length of the detection system 200. In one embodiment, L=725-mm.

Gravitational waves can cause differential stretching and compression of spacetime along the interferometer arms (i.e., the mirrors 230), resulting in a measurable change in ΔL. The strain h quantifies this relative change in spacetime. In the absence of changes to the index of refraction, the strain h represents the fractional change in the optical path length due to the influence of spacetime distortions and is also considered to be the magnitude of the gravitational wave at the point. Given the radial distribution of the energy within the spark, the radial energy can be strongest at the center and create a spacetime contraction from the center. One expression for the energy density of the spark is provided in Equation 9:

$${T}_{00} = - \frac{{c}^{4}}{8 π G} \frac{{v}_{s}^{2}}{4} {( \frac{df}{dr} )}^{2} \qquad ( 9 )$$

Next, if a shaping function is used as set forth in Equation 10:

$$f ( r ) = - {ae}^{- {β ( r - {r}_{0} )}^{2}} \qquad ( 10 )$$

Having a derivative as set forth in Equation 11:

$$\frac{df ( r )}{dr} = 2 α β ( r - {r}_{0} ) {e}^{- {β ( r - {r}_{0} )}^{2}} \qquad ( 11 )$$

Results in a new expression for energy density as set forth in Equation 12:

$${T}_{00} = - \frac{{c}^{4}}{2 π G} {v}_{s}^{2} {α}^{2} {{β}^{2} ( r - {r}_{0} )}^{2} {e}^{- 2 {β ( r - {r}_{0} )}^{2}} \qquad ( 12 )$$

where
Vₛ—the displacement of the fringe divided by the duration of the spark pulse.

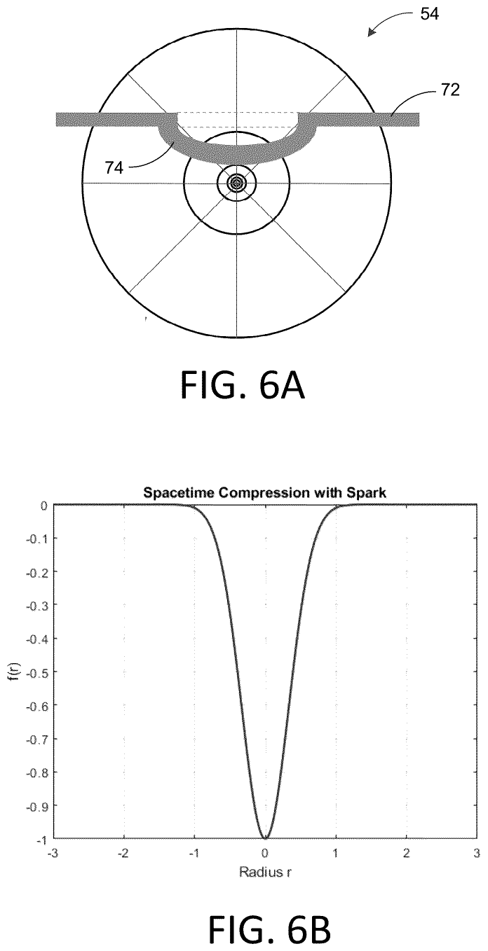

FIGS. 6A and 6B show an example of the change in optical path length due to spacetime compression at the center of the spark. As shown in FIG. 6A, the path 72 of a laser beam is altered to a distorted path 74 as a result of the compression of spacetime at the center of the spark 54. FIG. 6B shows that spacetime compression occur near the center of the spark and reduces as the distance from the center increases.

To analyze the fringe movement, the time series data from the video of the screen 244 captured by camera 242 needs to be extracted. In one embodiment, a rate of 30 frames per second from the camera can capture displacements that occur with a spark pulse rate of no faster than approximately five pulses per second. Each frame was captured and rotated to provide vertical fringe lines, a threshold was applied to remove extraneous influences, and the pixels were summed vertically and smoothed. The movement of the peaks is tracked and compared against a basis frame where there is no fringe movement. The displacement is calculated as the average difference of the peak positions when the spark is on versus when it is off. The difference in the peak is related to the wavelength of the laser 210 and thus permits a determination of the scale factor for the number of pixels per nanometer. The fringe movement induced by the spark can be calculated for various distances and orientations in nanometers.

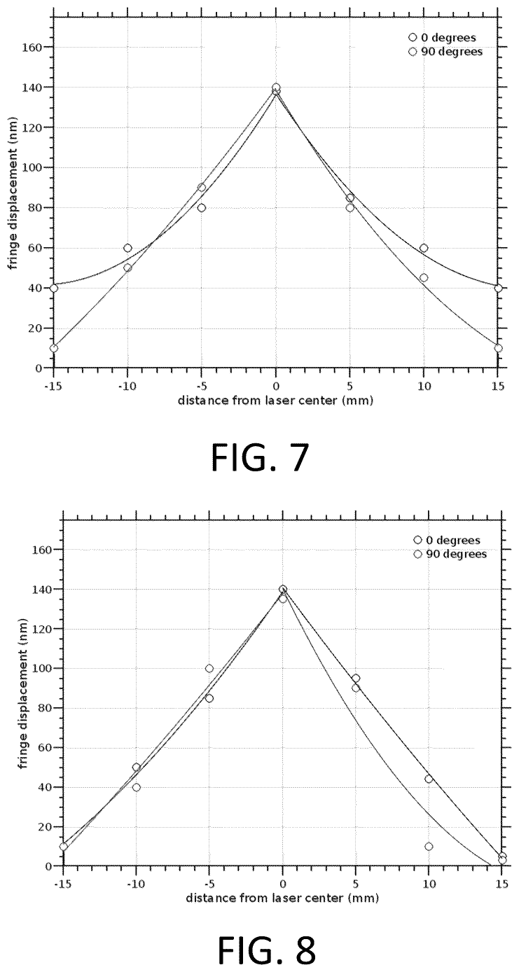

Several parameters such as (1) spark gap distance, (2) spark input power, which ostensibly affects the spark pulse length and rate and thus the energy density, (3) the distance between the spark and the laser, and (4) the orientation of the spark with the laser beam can be adjusted to affect fringe displacement. FIGS. 7-12 show how some variations in the previously mentioned parameters can affect fringe displacement.

FIG. 7 shows the magnitude of the fringe displacement versus the distance from the center of a laser beam from a 650 nm laser and a 5 mm gap width in the spark-gap assembly. The magnitude peaked around 140 mm and fell in a l/r² fashion. The direction of displacement was in the direction of increase in optical path length although it did ring as it settled back down after the pulse ended. Note that the orientation of the spark (i.e., 0° or) 90° to the laser did not significantly affect the result. FIG. 8 shows the same results as FIG. 7 except that a laser beam from a 532 nm laser was used. In FIG. 8, the displacement peak was also around 140 nm in the direction of increased L.

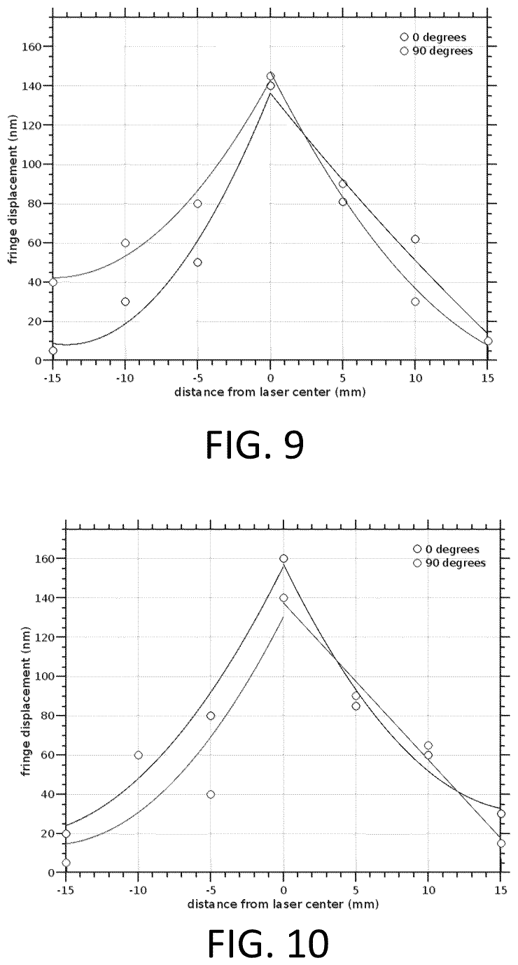

FIG. 9 shows the magnitude of the fringe displacement versus the distance from the center of a laser beam from a 650 nm laser and a 2.5 mm gap width in the spark-gap assembly. Decreasing the spark gap width serves to decrease the spark duration, thus increasing the repetition rate, while at the same time increasing the energy density for the same input power level due to the decreased volume of the spark. FIG. 10 shows the same results as FIG. 9 except that a laser beam from a 532 nm laser was used. FIGS. 9 and 10 show slightly higher maximum fringe displacement values while having the same behavior as seen in FIGS. 7 and 8 with respect to distance and orientation.

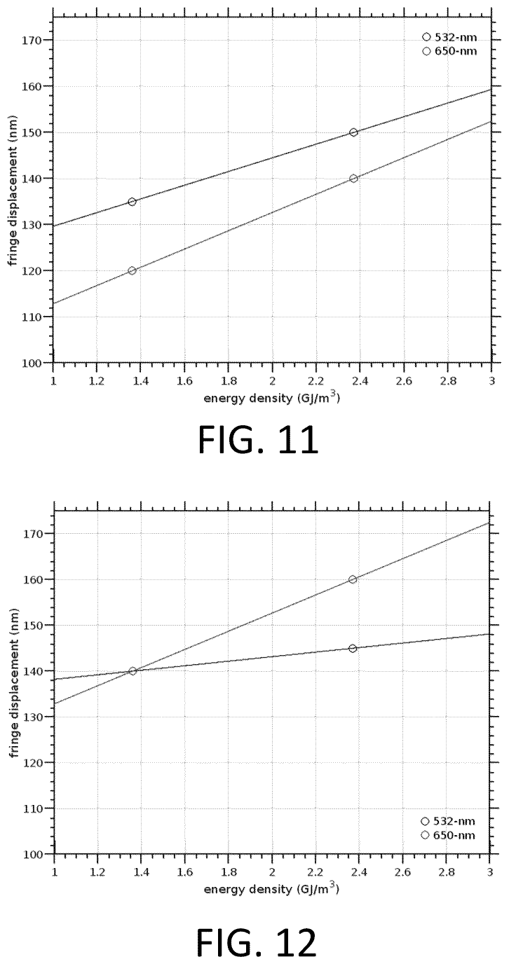

FIG. 11 shows the magnitude of the fringe displacement versus energy density for a spark/laser orientation of 90°. Adjusting the input power levels and the gap widths resulted in isolated energy density values of 1.4 and 2.4 GJ/m³. FIG. 12 shows the same results as FIG. 11 except that a spark/laser orientation of 0° was used. The displacements shown in FIGS. 11 and 12 show their dependence on the energy density in a way that corresponds to space-time distortion. The spark/laser orientation of both 0° and 90° gave similar results.

Rapidly forming high energy sparks in the spark-gap assembly 50 can produce gravitational wave-like effects. Given the lack of significant vibrational, shockwave, or refractive-index influences, the observed fringe movement or displacement (as seen in FIGS. 7-12) can be attributed to space-time distortions. The use of the detection system 200 shows that fringe movement is synchronized with the spark formation and the magnitude and frequency of the fringe movement scales proportionally with the power applied to the spark-gap assembly 50 and aligns with the frequency of the spark formation. This indicates a change in the optical path length (OPL) near the spark region.

In addition, the fringe movement is unaffected by the orientation of the spark relative to the laser beam. Both perpendicular and parallel orientations produce the same fringe movement magnitude and pattern. The orientation independence shows that traditional refractive index changes, which are typically angle dependent, are not the primary mechanism responsible for the observed fringe shift.

The fringe movement characteristics remain consistent across different laser wavelengths (e.g., 532 nm and 650 nm). The wavelength independence of the fringe movement characteristics is inconsistent with traditional refractive index changes, which would result in chromatic dispersion. The wavelength-independence of the fringe movement characteristics can be due to spacetime distortion or gravitational wave effects.

Further, introducing white light near the spark produces no observable chromatic dispersion or rainbow-like effect within the plasma region. A true refractive index change would likely cause dispersion as different wavelengths of light refract differently. The absence of dispersion shows that the observed fringe movement is not due to traditional refractive index change.

The magnitude of the fringe movement decreases with increasing distance from the spark, dropping off completely around 20 mm. The drop-off is symmetrical on both sides of the laser beam. The symmetry and distance dependence of the decrease in fringe movement shows a localized effect originating from the spark region, indicating a spherical or radial field effect such as a gravitational wave.

In one embodiment, replacing air with helium in the generation system does not eliminate the fringe movement. In fact, the fringe movement effect becomes more pronounced, and the spark forms more easily in helium at lower energy levels. The formation of the spark in a helium environment shows that traditional refractive index changes are not the primary cause for the fringe movement, as the generation system would behave differently in helium compared to air.

Increasing the input power to the spark-gap assembly proportionally increases both the fringe movement and the frequency of spark formation. This behavior supports the idea that the spacetime distortion effect is related to energy density in the spark region. Furthermore, the rise time of the spark pulse was approximately 1/10 of the pulse width, so the power density can be determined with Equation 13:

$$p = \frac{du}{dt} = \frac{Δ u}{Δ t} \qquad ( 13 )$$

The pulse formation time can be related to the input power and dependent upon the gap length. For a 2.5 mm gap, the power density can be as high as 1×10¹¹ W/m³, and when the gap was 5 mm the power density can be as high as 8×10¹⁰ W/m³. The energy density can be dependent upon the velocity of the distortion. The maximum displacements are between 140 nm and 160 nm in periods of 0.17 and 0.23 seconds for the gap widths of 5 mm and 2.5 mm, respectively. Calculated velocities then are in the range of 650 nm/s to 850 nm/s. The relatively slow displacement velocities serve to reduce the required energy density for the shaping function.

The generation system 100 and the spark-gap assembly 50 can be used to produce an effect that cannot be solely attributed to traditional refractive index changes, shock waves, or electrostatic interactions. The consistency of the fringe movement across orientations, the lack of chromatic dispersion, and the persistence of the effect in different spark/laser orientations shows the presence of space-time distortion or gravitational wave generation.

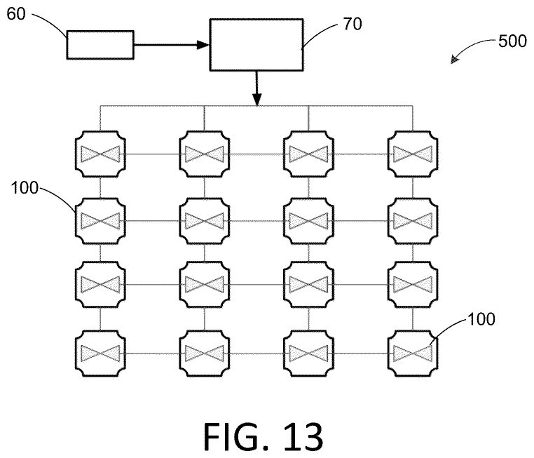

In some embodiments, the generation system or spark-gap system 100 and the spark-gap assembly 50 can be arranged as a planar grid or phased array of ‘gwavelets’ that can operate in tandem to produce controlled and steerable gravitational wave patterns. When multiple generation systems (or “gwavelets”) 100 are placed in series, the fringe movement appears to be additive, with each spark-gap system 100 contributing to the overall displacement. The additive nature of the fringe movements can provide a cumulative or constructive interference mechanism that can be used with the array of “gwavelets.” The array of “gwavelets” can provide for spacetime compression and expansion that can be used to form larger, complex and more coherent spacetime distortion patterns (e.g., a beam at the center of the array). FIG. 13 shows an embodiment of an array of spark-gap systems. As shown in FIG. 13, an array 500 of sixteen spark-gap systems 100 is arranged in a 4×4 configuration with each generation system 100 being driven by its own transformer 40 and signal generator 10. The control system 60 can be used to control power conditioning and switching circuitry 70, which in turn can be used to provide power to individual spark-gap systems 100 and provide for synchronized spark formation in the spark-gap systems 100.

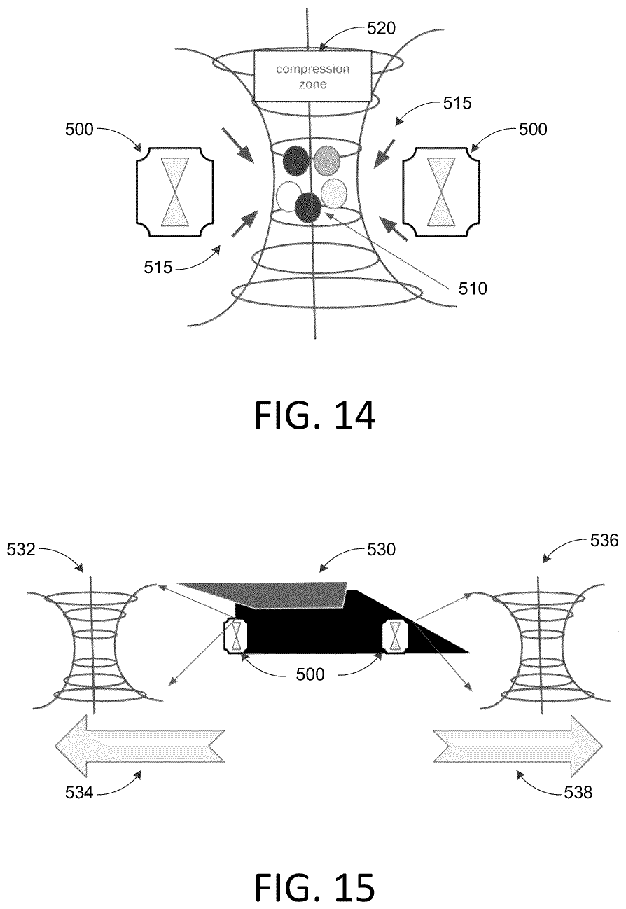

In some embodiments, one or more arrays of spark-gap systems can be used to provide spacetime compression for fusion reaction stabilization. FIG. 14 shows an embodiment of arrays of spark-gap systems used for fusion reaction stabilization. As shown in FIG. 14, the spark-gap system arrays 500 can be used to stabilize plasma 510 in a fusion reaction chamber by creating spacetime compression zones 520 around the plasma. The spacetime distortion provides compression forces (as shown by arrows 515) in the region around deuterium and tritium atoms to help contain the plasma and prevent turbulence, thereby stabilizing the reaction and the reaction time.

In some embodiments, one or more arrays of spark-gap systems can be used for a propulsion system based on spacetime distortion. FIG. 15 shows an embodiment of arrays of spark-gap systems used for propulsion. As shown in FIG. 15, a spacecraft propulsion system can utilize spacetime distortion created by spark-gap system arrays 500 to move a spacecraft 530. The propulsion system works by creating regions of spacetime compression and expansion, resulting in thrust without the need for conventional fuel. A first spark-gap system array 500 can be used to create a spacetime compression or contraction 532 at the front of the spacecraft 530 to generate a reverse thrust 534 for the spacecraft 530 and a second spark-gap system array 500 can be used to create a spacetime expansion 536 at the rear of the spacecraft 530 to generate forward thrust 538 for the spacecraft 530.

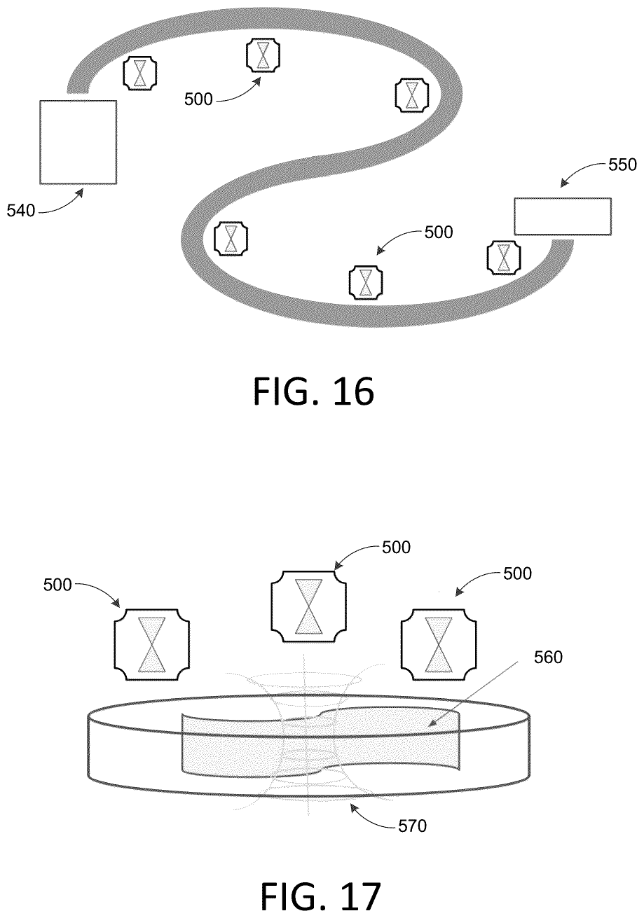

In some embodiments, one or more arrays of spark-gap systems can provide dynamic spacetime focusing for electromagnetic beam control. FIG. 16 shows an embodiment of arrays of spark-gap systems used for electromagnetic beam control. As shown in FIG. 16, spark-gap system arrays 500 can be used to focus electromagnetic beams through spacetime distortion for material processing (e.g., cutting or material absorption) or communication. The spark-gap system arrays 500 can be used to concentrate or focus energy from an electromagnetic beam source 540 onto a target 550 through spacetime manipulation. As the electromagnetic beam travels from the source 540 to the target 550, the electromagnetic beam interacts with the distortions from the spark-gap system arrays 500 to focus and direct the beam.

In some embodiments, one or more arrays of spark-gap systems can provide spacetime distortion for medical applications. FIG. 17 shows an embodiment of arrays of spark-gap systems used for medical applications. FIG. 17 shows a medical device that uses the spark-gap system arrays 500 to create controlled spacetime distortions 570 for focused energy delivery in non-invasive medical procedures. The spacetime distortion 570 allows energy to be delivered precisely to a target area in human tissue 560 without the need for surgery.

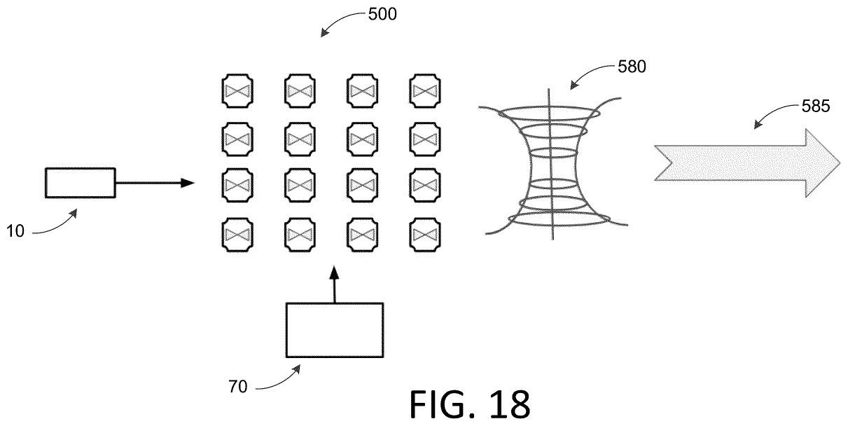

In some embodiments, one or more arrays of spark-gap systems can provide field modulation for high-speed communications that can propagate in multiple media. FIG. 18 shows an embodiment of a spark-gap system array used for high-speed communication. The spark-gap system array 500 can be used to modulate spacetime and electromagnetic waves for high-speed communication applications. Signals from a signal generator or communication system 10 can be encoded in the spacetime distortion 580 to generate a modulated signal 585, allowing for potential faster-than-light communication. A receiver (not shown) can detect and decode the modulated signals.

In some aspects, information can be encoded into gravitational waves by controlling the initiation of the spark discharges with an external signal source. In this approach, the spark gap is triggered by a driver circuit (e.g., communication system 10 and power conditioning and switching circuitry 70) that follows a predefined modulation pattern, allowing the emitted spacetime perturbations to carry data in much the same way as electromagnetic signals are modulated. Amplitude modulation can be achieved by varying the discharge energy of successive sparks, frequency modulation by adjusting the repetition rate of the discharges, and phase modulation by synchronizing or offsetting multiple spark-gap sources in the spark-gap system array 500. By directly linking the timing and intensity of the spark events to a data stream, the spark-gap system 100 is able to generate gravitational waveforms that encode digital information, forming the basis for a modulated gravitational wave communication system.

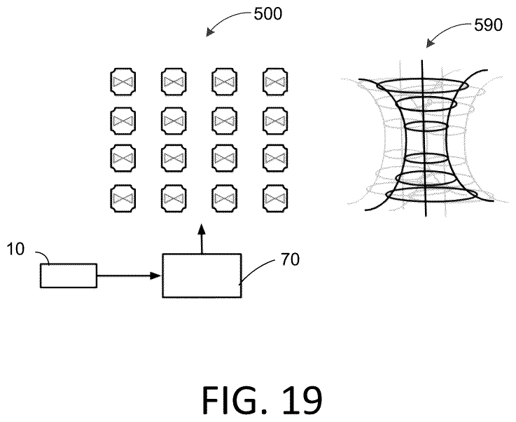

In some embodiments, the spark-gap system array can provide a time-varying voltage for spacetime distortion control. FIG. 19 shows an embodiment of array of spark-gap systems with time-varying voltage. The spark-gap system array 500 can be driven by either a constant or time-varying voltage from the power conditioning and switching circuitry 70 to produce different spacetime distortion profiles 590. By controlling the voltage input to the spark-gap system array 500, the geometry and intensity of the spacetime distortion 590 can be finely tuned for specific applications.

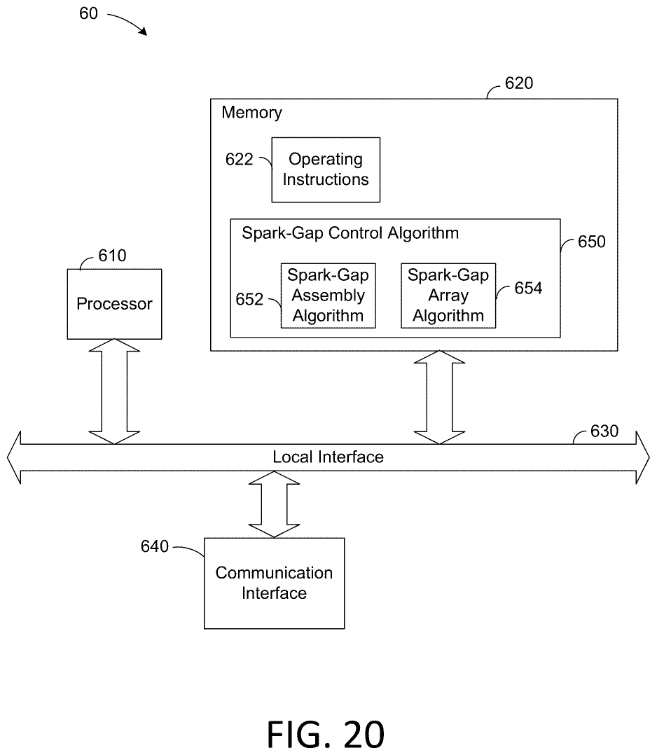

FIG. 20 is a block diagram of an embodiment of a control system that can be used with the gravitational wave generation systems. The control system 60 can include one or more processors 610 to control the operations of the components of the spark-gap systems 100 and/or the power conditioning and switching circuitry 70 when “gwavelet” arrays 500 are used. As described herein, a processor 610 may include any suitable processing device such as a general-purpose processor or microprocessor executing instructions from memory, hardware implementations of processing operations (e.g., hardware implementing instructions provided by a hardware description language), any other suitable processor, or any combination thereof. In one embodiment, processor 610 may be a microprocessor that executes instructions stored in memory 620. Memory 620 includes any suitable volatile or non-volatile memory capable of storing information (e.g., instructions and data for the operation and use of the spark-gap system 100), such as RAM, ROM, EEPROM, flash, magnetic storage, hard drives, any other suitable memory, or any combination thereof.

The processor 610 may be in communication with other components of the control system 60 via an internal communication interface 630. Internal communication interface 630 may include any suitable interfaces for providing signals and data between processor 610 and the other components of the control system 60. This may include communication buses such as I2C, SPI, USB, UART, GPIO and Ethernet. The control system 60 may also include a communication interface 640 to provide for wireless and/or wired communications with the other components of the spark-gap system 100 (e.g., transformers 40, signal generators 10, spark-gap assemblies 50, etc.) or the power conditioning and switching circuitry 70. In one embodiment, communication interface 640 may include a wireless interface that communicates using a standardized wireless communication protocol (e.g., Wi-Fi, ZigBee, Bluetooth®, Bluetooth® low energy, Cellular, etc.) or a proprietary wireless communication protocol operating at any suitable frequency such as 900 MHz, 2.4 GHz, or 5.6 GHz.

In one embodiment, memory 620 of the control system 60 may include memory for executing instructions with processor 610, memory for storing data, and a plurality of sets of instructions to be executed by processor 610. Although memory 620 may include any suitable instructions, in one embodiment the instructions may include operating instructions 622 for generally controlling the operation of the control system 60 and a spark-gap control algorithm 650, which can include a spark-gap assembly control algorithm 652 and a spark-gap system array control algorithm 654.

The operating instructions 622 and/or the spark-gap control algorithm 650 (including the spark-gap assembly control algorithm 652 and the spark-gap system array control algorithm 654) can be implemented in software, hardware, firmware, or any combination thereof. In the control system 60 shown by FIG. 20, the operating instructions 622 and/or the spark-gap control algorithm 650 can be implemented in software and stored in memory 620. When the operating instructions 622 and/or the spark-gap control algorithm 650 are implemented in software, the processor 610 may execute instructions of the operating instructions 622 and/or the spark-gap control algorithm 650 to perform the functions ascribed herein to the corresponding components. However, other configurations of the operating instructions 622 and/or the spark-gap control algorithm 650 are possible in other embodiments. Note that the operating instructions 622 and/or the spark-gap control algorithm 650, when implemented in software, can be stored and transported on any computer-readable medium for use by or in connection with an instruction execution apparatus that can fetch and execute instructions. In the context of this document, a “computer-readable medium” can be any non-transitory means that can contain or store code for use by or in connection with the instruction execution apparatus. In addition, it is to be understood that the control system 60 can include other components not specifically identified herein.

In some embodiments, the spark-gap system 100 can induce a spacetime distortion at the center of a spark plasma that has a sufficiently high energy density (i.e., in excess of 1 GJ/m³). Fringe displacements of up to 160 nm associated with an increase in optical path length can be observed with detection system 200. Minor gravitational lensing that occurs at the center of the spark can cause the observed distortion in the optical path (or laser path).

In various embodiments, an apparatus for producing spacetime distortions is provided. The apparatus can be capable of generating gravitational waves and sudden transitions in the index of refraction and includes: a spark-gap assembly having of tungsten tips, a transformer providing high-voltage power to generate plasma, a control system that allows for constant or pulsed operation of the device, and means of detecting optical path length changes using interferometry. The apparatus can also be used for gravitational wave generation, where the spark-gap assembly generates energy densities sufficient to produce gravitational waves in a controlled, localized region. The apparatus can also be used for an index of refraction transition, where the plasma formed in the spark-gap results in a measurable change in the index of refraction of the surrounding medium.

In various embodiments, the apparatus can have a customizable spark-gap configuration, where multiple spark-gap tips are arranged to produce customizable spacetime distortions and energy fields. The apparatus can be configured for operation in air, an inert gas such as helium, or in a vacuum to optimize the generation of gravitational waves or refraction changes. The apparatus can have a time-varying voltage input, where the spark-gap can be driven by a time-varying voltage, allowing for the production of varying spacetime distortion profiles. The apparatus can have a spacetime distortion geometry for fusion reaction stabilization, where the spark-gap assembly is configured to generate spacetime distortions in a controlled geometry designed to stabilize fusion reactions. The spacetime distortions can be used to confine plasma within a fusion reactor, thereby improving the stability of the reaction by maintaining the plasma in a specific shape or pressure zone. By dynamically shaping spacetime, the system minimizes plasma turbulence and fluctuations that typically disrupt the fusion process.

In various embodiments, the apparatus can generate spacetime compression in a small, focused region to initiate or enhance nuclear reactions by concentrating energy density in a precise location. The spacetime distortion geometry can be adjusted in real-time based on the requirements of the reaction, ensuring that energy is delivered directly to the reaction zone, enhancing efficiency and control. The apparatus can produce controlled spacetime distortion fields behind a propulsion vehicle to generate thrust through spacetime compression and expansion. By adjusting the geometry of the spacetime distortions, the apparatus can provide propulsion with minimal fuel consumption by exploiting the energy density gradient produced by localized spacetime curvatures. The apparatus may use a phased array of spark-gap elements to direct spacetime distortion in specific directions, creating thrust for interstellar travel. The apparatus can be used for spacetime distortion for gravity-assisted maneuvering. Spacetime distortions can be shaped to create localized gravitational wells or perturbations, which can be used for maneuvering spacecraft without the need for traditional chemical or ion propulsion. By controlling the size, shape, and gradient of the distortion field, the apparatus can simulate gravitational pull in specific directions, enabling non-Newtonian maneuvering capabilities.

In various embodiments, the apparatus can provide spacetime distortion for enhanced electromagnetic interactions. Spacetime distortions can be configured to focus electromagnetic energy, such as radiofrequency (RF) or laser beams, onto specific material targets, thereby enhancing material interactions such as melting, welding, or cutting. The apparatus allows for real-time control of the geometry and size of the spacetime distortions, enabling precise manipulation of energy density on the material's surface. The apparatus can provide spacetime shaping for electromagnetic field modulation. Spacetime distortions can be shaped to influence the propagation of electromagnetic fields in such a way that the refractive index of the medium is modulated dynamically, enabling the apparatus to encode information within spacetime distortions for high-speed communication or signal processing. The apparatus can provide energy focusing via shaped spacetime compression. Spacetime distortions can be used to concentrate energy within a designated region, improving energy efficiency in industrial processes such as material synthesis, plasma confinement, or nuclear fusion initiation. The geometry of the distortion field can be adapted to the specific requirements of each application, allowing for precise control over the location and intensity of the energy focus. The apparatus can be used to create localized spacetime distortions for precision medical applications, including non-invasive surgeries where focused gravitational or refractive effects are used to manipulate tissues without direct physical contact. The apparatus can shape spacetime to focus or steer energy, enabling applications such as targeted radiation therapy or focused ultrasound.

In various embodiments, the apparatus can be used for array-based spacetime distortion control for industrial applications, where an array of spark-gap elements can be used to produce a network of spacetime distortions for industrial manufacturing processes that require precise energy delivery or structural manipulation at microscopic or nanoscopic scales. The apparatus can be tuned to shape spacetime distortion patterns, allowing for 3D printing, additive manufacturing, or material deposition with sub-micrometer accuracy. The apparatus can be used for spacetime distortion geometry for propulsion in fluids or the atmosphere, where the generated spacetime distortions are utilized to provide propulsion in fluid or atmospheric environments, where the compression of spacetime behind the apparatus reduces drag and increases the effective velocity of the vehicle through the medium.

While this application contains many specifics, these should not be construed as limitations on the scope of any invention or of what may be claimed, but rather as descriptions of features that may be specific to particular aspects of particular inventions. Certain features that are described in this application in the context of separate aspects of the teachings can also be implemented in combination in a single aspect. Conversely, various features that are described in the context of a single aspect can also be implemented in multiple aspects separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the various aspects described in this application should not be understood as requiring such separation in all aspects.

Only a few implementations and examples are described, and other implementations, enhancements and variations can be made based on what is described and illustrated in this application.

What is claimed is:

1. An apparatus to generate gravitational waves comprising:
a spark-gap assembly having a pair of tungsten tips;
a transformer providing high-voltage power to generate plasma;
a control system that allows for constant or pulsed operation of the device; and
means for detecting optical path length changes using interferometry.

2. The apparatus of claim 1, wherein the spark-gap assembly is configured to generate energy densities sufficient to produce gravitational waves in a localized region of the spark-gap assembly.

3. The apparatus of claim 1, wherein the spark-gap assembly is configured to form plasma that results in a measurable change in the index of refraction of a surrounding medium of the spark-gap assembly.

4. The apparatus of claim 1, further comprising a plurality of spark-gap assemblies arranged in an array to produce customizable spacetime distortions and energy fields.

5. The apparatus of claim 1, wherein the spark-gap assembly is configured to operate in at least one of air, an inert gas, or a vacuum.

6. The apparatus of claim 1, wherein the spark-gap assembly is configured to be driven by a time-varying voltage to produce varying spacetime distortion profiles.
